(19) United States
(12) Patent Application Publication
(10) Pub. No.: US 2008/0046919 A1
(43) Pub. Date: Feb. 21, 2008

(54) METHOD AND SYSTEM FOR COMBINING AND SYNCHRONIZING DATA STREAMS

(75) Inventors: Michael Carmi, Herzliya (IL); Dubi Sandmann, Herzliya (IL)

Correspondence Address: FOLEY & LARDNER LLP, 150 EAST GILMAN STREET, P.O. BOX 1497, MADISON, WI, 53701-1497, US

(73) Assignee: Targeted Media Services Ltd.

(21) Appl. No.: 11/780,067

(22) Filed: Jul. 19, 2007

Related U.S. Application Data
(63) Continuation-in-part of application No. 11/758,237, filed on Jun. 5, 2007.
(60) Provisional application No. 60/837,942, filed on Aug. 16, 2006.

(51) Int. Cl. H04N 7/025

(52) U.S. Cl. 725/32

(57) ABSTRACT

A method of presenting an advertisement includes receiving a content stream from a content provider. The received content data stream is provided to a first input of a display adaptor such that the received content data stream is presented on a display. Advertisement metadata corresponding to an advertisement is received. The advertisement metadata includes a presentation time for the advertisement. An advertisement data stream corresponding to the advertisement is also received. The received advertisement data stream is provided to a second input of the display adaptor such that the received advertisement data stream is presented on the display at the presentation time.

### CROSS-REFERENCE TO RELATED APPLICATIONS

This application claims the benefit of U.S. Provisional Patent Application Ser. No. 60/837,942 that was filed Aug. 16, 2006, and U.S. Non-Provisional patent application Ser. No. 11/758,237 filed Jun. 5, 2007, the disclosures of which are hereby incorporated by reference in their entirety.

### FIELD

The subject of the disclosure relates generally to streaming media over a network. More specifically, the disclosure relates to the combination and synchronization of a content data stream and an advertisement data stream based on parameters provided by a content provider, criteria provided by an advertiser, and viewer data provided by a user device.

### BACKGROUND

Advertisements included in video streams sent over the Internet have a unique advantage over advertising presented by a television. Such advertisements can be targeted to specific viewers. One problem associated with such advertisement (ad) is accurate metering of the number and duration of advertisement exposures. Current metering systems rely on cookies that are added to the media in which the ad is placed. A cookie is a very small text stream inserted on a user's computer by a Web server and is unique to the browser installed at the user's computer. Cookies are often used by Web servers to identify users and to authenticate, track, and maintain specific information about users. First-party cookies are sent to and stored on the user's computer by a website that has been visited by the user. Third-party cookies are sent to and stored on the user's computer by a Web site having a domain different than the website visited by the user. For example, a third-party cookie may be sent from an advertising server that delivered an ad to the user's computer or may be a third-party tool used to measure websites visited by the user.

To bill the advertiser correctly, the cookies should report to a server whether an ad was delivered and exposed to a user's computer. Users, however, may remove cookies from their computers, for example, as part of a disk clean-up process. Because the user removed the cookie from their computer, the advertisement server may deposit another cookie on the user's computer potentially leading to an inflated estimate of the unique users who have received the advertisement. Such inflated estimates result in overbilling and eventually may cause advertisers to stop advertisement campaigns supported by unreliable content publishers. Thus, what is needed is a method and a system for reliably calculating and reporting advertisement exposures.

### SUMMARY

An exemplary method of presenting an advertisement includes receiving a content stream from a content provider. The received content data stream is provided to a first input of a display module such that the received content data stream is presented on a display. Advertisement metadata corresponding to an advertisement is received. The advertisement metadata includes a presentation time for the advertisement. An advertisement data stream corresponding to the advertisement is also received. The received advertisement data stream is provided to a second input of the display module such that the received advertisement data stream is presented on the display at the presentation time.

Another exemplary method of presenting an advertisement includes receiving advertisement data corresponding to the advertisement, where the advertisement data includes a content criterion of an advertiser. Content data corresponding to content is received, and the received advertisement data is compared to the received content data to determine whether the content criterion of the advertiser is satisfied. The advertisement and a presentation time for the advertisement are received. The advertisement and the presentation time are provided to a user device if the content criterion is satisfied.

An exemplary advertising system includes a content provider, an advertiser, and an advertisement manager. The advertisement manager is configured to receive advertisement data from the advertiser, where the advertisement data corresponds to an advertisement and comprises criteria of the advertiser. Content data from the content provider is also received, where the content data corresponds to content. Viewer data from a user device is also received. The received advertisement data is compared to the received content data and the received viewer data to determine whether the criteria of the advertiser is satisfied. The advertisement and a presentation time for the advertisement are received from the advertiser, and if the criteria is satisfied, the presentation time and the advertisement are provided to a user device.

Other principal features and advantages of the invention will become apparent to those skilled in the art upon review of the following drawings, the detailed description, and the appended claims.

### BRIEF DESCRIPTION OF THE DRAWINGS

Exemplary embodiments of the invention will hereafter be described with reference to the accompanying drawings, wherein like numerals denote like elements.

FIG. 1 depicts a block diagram of an advertisement processing system in accordance with an exemplary embodiment.

FIG. 2 depicts a block diagram of a device which controls selection of an advertisement for presentation at a user device of the advertisement system of FIG. 1 in accordance with an exemplary embodiment.

FIG. 3 depicts a block diagram of the user device of the advertisement system of FIG. 1 in accordance with an exemplary embodiment.

FIG. 4 depicts a flow diagram illustrating exemplary operations performed in monitoring presentation of an advertisement during presentation of a media stream in accordance with an exemplary embodiment.

FIG. 5 depicts a flow diagram illustrating exemplary operations performed in selecting an advertisement for presentation with a media stream and billing a customer for an exposure time to the presented ad in accordance with an exemplary embodiment.

FIG. 6 depicts a block diagram of an advertising system in which content data streams and advertising data streams are combined and/or synchronized in accordance with an exemplary embodiment.

FIG. 7 depicts a flow diagram illustrating operations performed by an advertisement manager in accordance with an exemplary embodiment.

FIG. 8 depicts a flow diagram illustrating operations performed by a data stream application in accordance with an exemplary embodiment.

### DETAILED DESCRIPTION

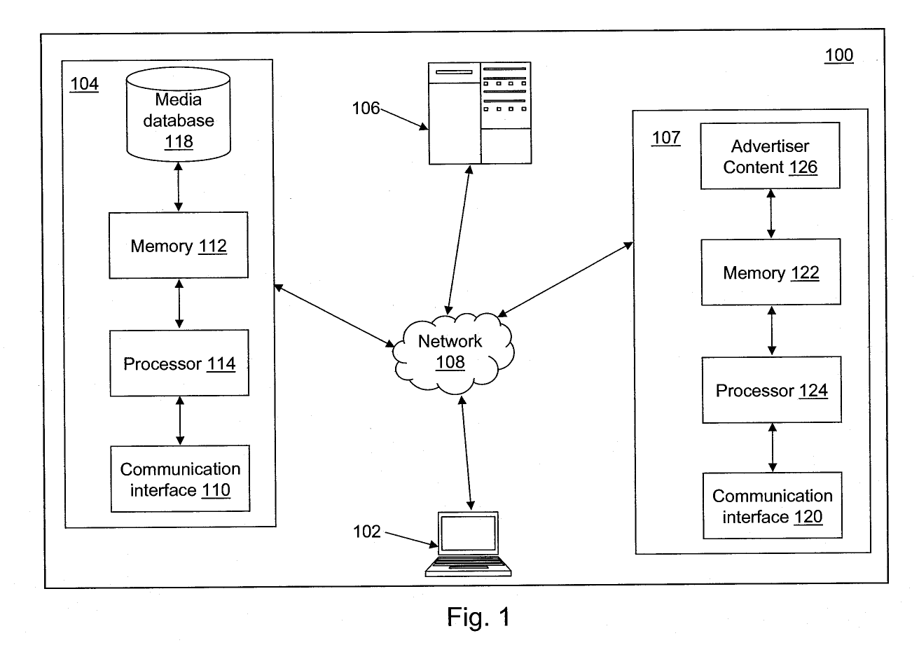

With reference to FIG. 1, a block diagram of an advertisement processing system 100 is shown in accordance with an exemplary embodiment. Advertisement processing system 100 may include a user device 102, a media stream source device 104, an advertisement controller device 106, and an advertiser device 107. User device 102, media stream source device 104, advertisement controller device 106, and advertiser device 107 each may be any type of computing device including computers of any form factor such as a laptop, a desktop, a server, etc., an integrated messaging device, a personal digital assistant, a cellular telephone, an iPod, etc. User device 102, media stream source device 104, advertisement controller device 106, and advertiser device 107 may interact using a network 108 such as a local area network (LAN), a wide area network (WAN), a cellular network, the Internet, etc. In an alternative embodiment, user device 102, media stream source device 104, advertisement controller device 106, and/or advertiser device 107 may be connected directly. For example, media stream source device 104 may connect to advertisement controller device 106 using a cable for transmitting information between media stream source device 104 and advertisement controller device 106.

A computing device may act as a Web server providing information or data organized in the form of websites accessible over a network. A website may comprise multiple web pages that display a specific set of information and may contain hyperlinks to other web pages with related or additional information. Each web page is identified by a Uniform Resource Locator (URL) that includes the location or address of the computing device that contains the resource to be accessed in addition to the location of the resource on that computing device. The type of file or resource depends on the Internet application protocol. For example, the Hypertext Transfer Protocol (HTTP) describes a web page to be accessed with a browser application. The file accessed may be a simple text file, an image file, an audio file, a video file, an executable, a common gateway interface application, a Java applet, an active server page, or any other type of file supported by HTTP. In an exemplary embodiment, media stream source device 104, advertisement controller device 106, and/or an advertiser device 107 are Web servers. In another exemplary embodiment, media stream source device 104, advertisement controller device 106, and/or an advertiser device 107 are peers in a peer-to-peer network as known to those skilled in the art. In an exemplary embodiment, media stream source device 104, advertisement controller device 106, and/or an advertiser device 107 are the same device.

Media stream source device 104 may include a communication interface 110, a memory 112, a processor 114, and a media database 118. Different and additional components may be incorporated into media stream source device 104. For example, media stream source device 104 may include a display or an input interface to facilitate user interaction with media stream source device 104. Components of media stream source device 104 may be positioned in a single location, a single facility, and/or may be remote from one another. For example, the plurality of media streams may be located at different computing devices accessible directly or through a network.

Media stream source device 104 may include a plurality of media files stored in media database 118. Media database 118 may be organized in any format. Media database 118 may include multiple databases to improve data management and access. The multiple databases may be organized into tiers. Additionally, media database 118 may include a file system including a plurality of media files. The media file includes electronic data associated with the presentation of information to a user using various media such as video including a video weblog broadcast, audio, text, graphics, maps, animations, etc. to a user. Additionally, a hyperlink to any other digital source including a web page, other digital media such as video, audio, text, graphics, maps, animations, really simple syndication (RSS) feeds, etc. can be included in a media file of the plurality of media files. Each media file is generally associated with a type of media player capable of interpreting the electronic data to present the desired content to a user. Thus, each media file of the plurality of media files may have a variety of formats as known to those skilled in the art. Additionally, media stream source device 104 may aggregate and transmit live media streams from other digital media sources such as video and audio encoders, and other live sources as known to those skilled in the art. Media consumption methods may include all conventions such as VOD (video on demand), program streams, and live streams.

Communication interface 110 provides an interface for receiving and transmitting data between devices using various protocols, transmission technologies, and media as known to those skilled in the art. The communication interface may support communication using various transmission media that may be wired or wireless. Media stream source device 104 may have one or more communication interfaces that use the same or different protocols, transmission technologies, and media.

Memory 112 is an electronic holding place or storage for information so that the information can be accessed by processor 114 as known to those skilled in the art. Media stream source device 104 may have one or more memories that use the same or a different memory technology. Memory technologies include, but are not limited to, any type of random access memory (RAM), any type of read only memory (ROM), any type of flash memory, etc. Media stream source device 104 also may have one or more drives that support the loading of a memory media such as a compact disk (CD) or digital video disk (DVD) or ports that support connectivity with memory media such as flash drives.

Processor 114 executes instructions as known to those skilled in the art. The instructions may be carried out by a special purpose computer, logic circuits, or hardware circuits. Thus, processor 114 may be implemented in hardware, firmware, software, or any combination of these methods. The term “execution” is the process of running an application or the carrying out of the operation called for by an instruction. The instructions may be written using one or more programming language, scripting language, assembly language, etc. Processor 114 executes an instruction, meaning that it performs the operations called for by that instruction. Processor 114 operably couples with communication interface 110 and with memory 112 to receive, to send, and to process information. Processor 114 may retrieve a set of instructions from a permanent memory device and copy the instructions in an executable form to a temporary memory device that is generally some form of RAM. Media stream source device 104 may include a plurality of processors that use the same or a different processing technology.

Advertiser device 107 may include a communication interface 120, a memory 122, a processor 124, and advertiser content 126. Different and additional components may be incorporated into advertiser device 107. For example, advertiser device 107 may include a display or an input interface to facilitate user interaction with advertiser device 107. Components of advertiser device 107 may be positioned in a single location, a single facility, and/or may be remote from one another.

Advertiser content 126 may include electronic data associated with the presentation of information to a user such as various media including video, audio, text, graphics, a hyperlink to any other digital source including a web page, video, audio, text, graphics, RSS feeds, etc.

Communication interface 120 provides an interface for receiving and transmitting data between devices using various protocols, transmission technologies, and media as known to those skilled in the art. Advertiser device 107 may have one or more communication interfaces that use the same or different protocols, transmission technologies, and media.

Memory 122 is an electronic holding place or storage for information so that the information can be accessed by processor 124 as known to those skilled in the art. Advertiser device 107 may have one or more memories that use the same or a different memory technology. Advertiser device 107 also may have one or more drives that support the loading of a memory media such as a CD or DVD or ports that support connectivity with memory media such as flash drives.

Processor 124 executes instructions as known to those skilled in the art. Processor 124 may be implemented in hardware, firmware, software, or any combination of these methods. Processor 124 executes an instruction, meaning that it performs the operations called for by that instruction. Processor 124 operably couples with communication interface 120 and with memory 122 to receive, to send, and to process information. Processor 124 may retrieve a set of instructions from a permanent memory device and copy the instructions in an executable form to a temporary memory device that is generally some form of RAM. Advertiser device 107 may include a plurality of processors that use the same or a different processing technology.

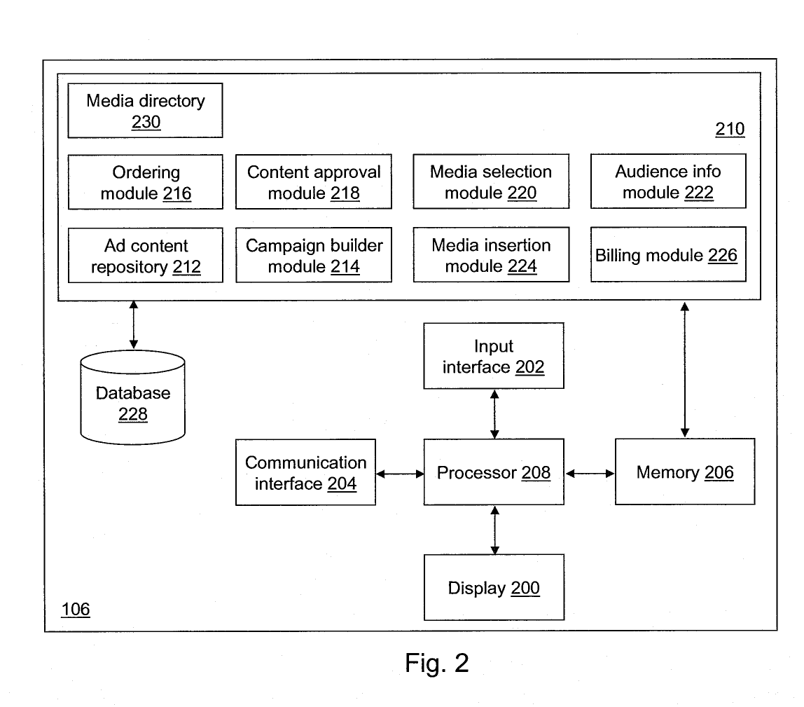

With reference to FIG. 2, advertisement controller device 106 may include a display 200, an input interface 202, a communication interface 204, a memory 206, a processor 208, an advertisement control application 210, and a database 228. Different and additional components may be incorporated into advertisement controller device 106. For example, advertisement controller device 106 may include speakers for presentation of audio media content. Display 200 presents information to a user of advertisement controller device 106 as known to those skilled in the art. For example, display 200 may be a thin film transistor display, a light emitting diode display, a liquid crystal display, or any of a variety of different displays known to those skilled in the art now or in the future.

Input interface 202 provides an interface for receiving information from the user for entry into advertisement controller device 106 as known to those skilled in the art. Input interface 202 may use various input technologies including, but not limited to, a keyboard, a pen and touch screen, a mouse, a track ball, a touch screen, a keypad, one or more buttons, etc. to allow the user to enter information into advertisement controller device 106 or to make selections presented in a user interface displayed on display 200. Input interface 202 may provide both an input and an output interface. For example, a touch screen both allows user input and presents output to the user.

Communication interface 204 provides an interface for receiving and transmitting data between devices using various protocols, transmission technologies, and media as known to those skilled in the art. Advertisement controller device 106 may have one or more communication interfaces that use the same or different protocols, transmission technologies, and media.

Memory 206 is an electronic holding place or storage for information so that the information can be accessed by processor 208 as known to those skilled in the art. Advertisement controller device 106 may have one or more memories that use the same or a different memory technology. Advertisement controller device 106 also may have one or more drives that support the loading of a memory media such as a CD or DVD or ports that support connectivity with memory media such as flash drives.

Processor 208 executes instructions as known to those skilled in the art. Thus, processor 208 may be implemented in hardware, firmware, software, or any combination of these methods. Processor 208 executes an instruction, meaning that it performs the operations called for by that instruction. Processor 208 operably couples with display 200, with input interface 202, with communication interface 204, and with memory 206 to receive, to send, and to process information. Processor 208 may retrieve a set of instructions from a permanent memory device and copy the instructions in an executable form to a temporary memory device that is generally some form of RAM. Advertisement controller device 106 may include a plurality of processors that use the same or a different processing technology.

Advertisement control application 210 performs operations associated with selection of advertisements presented to a user at user device 102 and a determination of billing an advertiser based on presentation of selected advertisements at user device 102. The operations may be implemented using hardware, firmware, software, or any combination of these methods. With reference to the exemplary embodiment of FIG. 2, advertisement control application 210 is implemented in software stored in memory 206 and accessible by processor 208 for execution of the instructions that embody the operations of advertisement control application 210. Advertisement control application 210 may be written using one or more programming languages, assembly languages, scripting languages, etc.

Advertisement control application 210 may include a plurality of modules that may be fully or partially integrated or execute independently. In an exemplary embodiment, the plurality of modules include an ad content repository 212, a campaign builder module 214, an ordering module 216, a content approval module 218, a media selection module 220, an audience information module 222, a media insertion module 224, a billing module 226, and a media directory 230. Ad content repository 212 may include content information associated with a plurality of ad files which may be stored in database 228. Database 228 may be organized in any format and may include multiple databases to improve data management and access. Database 228 may include a file system including a plurality of ad files. The ad file includes electronic data associated with the presentation of ads to a user in the form of various media such as video, audio, text, graphics, etc. The electronic data further may include a hyperlink to any other digital source including a web page, other digital media, audio material, graphics, textual data, digital streams, geographic information system data, RSS feeds, etc. Each ad file is generally associated with a type of media player capable of interpreting the electronic data to present the desired content to a user. Thus, each ad file of the plurality of ad files may have a variety of formats as known to those skilled in the art.

Media directory 230 is created by content and media providers who enter relevant data regarding the content and media, for example, into appropriate tables in media directory 230. The relevant data may include a media type (i.e., video or audio), a transmission mode (video-on demand or live), a content genre (family, adult only, sports, etc.), and terms and conditions associated with accepting an ad.

An advertiser defines a budget, a target audience, a desired exposure, etc. Campaign builder module 214 provides media types and possible providers and titles from media directory 230. Campaign builder module 214 recommends possible media mix alternatives. The advertiser selects the preferred alternative or plans a new campaign. Information associated with the ads is transferred into ad content repository 212 and the ads are transferred into database 228.

After matching the desired media with an ad, and receiving ad approval from content approval module 218, the advertiser places an order received by ordering module 216. Ordering module 216 issues the order to media insertion module 224 to have the ad ready to be transmitted to an audience of users at one or more user devices.

Content approval module 218 receives the ad content from ad content repository 212. The ad content is viewed by a user of media stream source device 104 who, according to the terms and conditions specified by the content provider in media directory 230, either approves the ad content or rejects it. The approval or rejection is transmitted to media selection module 220 to enable the transmission of the ad content to ordering module 216 and to media insertion module 224. An ad may be approved by only a subset of media providers of one or more media stream source devices. As a result, the ad may only be made available to the subset approving the ad.

Media selection module 220 checks the correlation of proposed media, as received from media directory 230, to the proposed ads. When a match occurs, media selection module 220 submits the ad content to content approval module 218 and waits for approval either by the media provider or another approval body accepted by the media provider, such as a content approval service. After receiving the approval, media selection module 220 places the ad in ordering module 216.

Audience information module 222 receives an internet protocol (IP) address, a media that a user is requesting, a time the user connected to media stream source device 104, viewing characteristics that matched the ad insertion criteria, and other data that the audience (user at user device 102) may provide such as the browser and operating system language of user device 102. The audience information is transmitted to the appropriate modules of the plurality of modules of advertisement control application 210 according to the type of data. The requested media and the IP address are transmitted to media stream source device 104 and to media insertion module 224 to enable the transmission of the correct ad to the user at the correct time according to the criteria specified in campaign builder module 214.

Timing information associated with the user's viewing of the ad, and other information specific to the advertisement, such as ad name, and positive confirmation of the presentation of the advertisement at display 300 of user device 102 may be transmitted from user device 102 to advertisement controller device 106 and stored in database 228 for the creation of rating and billing data. In an exemplary embodiment, positive confirmation of the presentation of the advertisement at display 300 of user device 102 is only transmitted from user device 102 to advertisement controller device 106 when the user views the entire advertisement as indicated using start and stop signals. The rating and viewing data are transmitted to billing module 226 to provide the correct billing. The viewing period and other data that may be gathered from the user at user device 102 may be transmitted to advertiser device 107 to be used as marketing information.

Media insertion module 224 includes a table describing conditions for matching ads with content, a targeted audience, available media channels, insertion timing and duration, media, etc. The table may be created using the information received from media directory 230, media selection module 220, and/or ordering module 216. Media insertion module 224 determines if a user matching the criteria entered by the advertiser in campaign builder module 214 is present and ready to receive ads. When such a match between content, media, audience (user), and ad is identified, media insertion module 224 transmits the ad directly to the indicated user device 102.

Billing module 226 may receive pricing information from media directory 230 and actual activities (connection to specific media, actual rating, and confirmation of advertisement presentation) from database 228 and an indication of interactive communication between a user and advertiser device 107. Billing module 226 calculates the payment due from the advertiser and a commission due to the operator of advertisement controller device 106. The billing data may be transmitted as a call detail record to an external billing system.

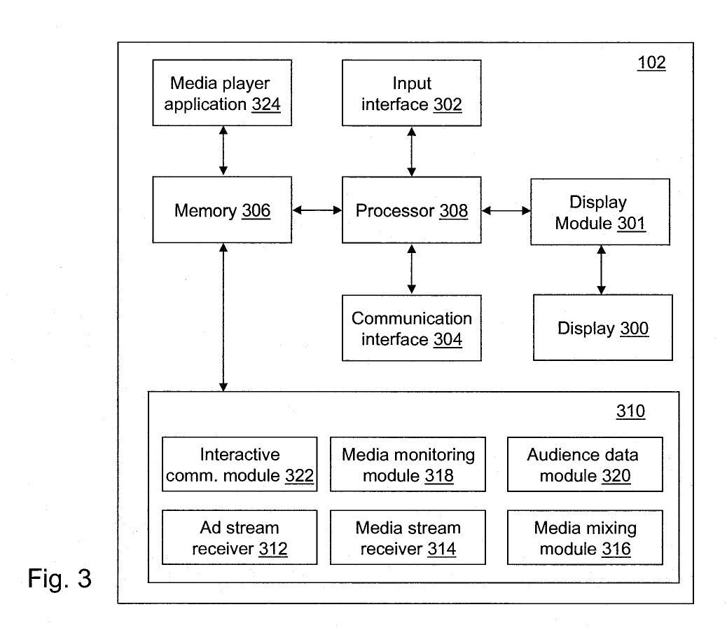

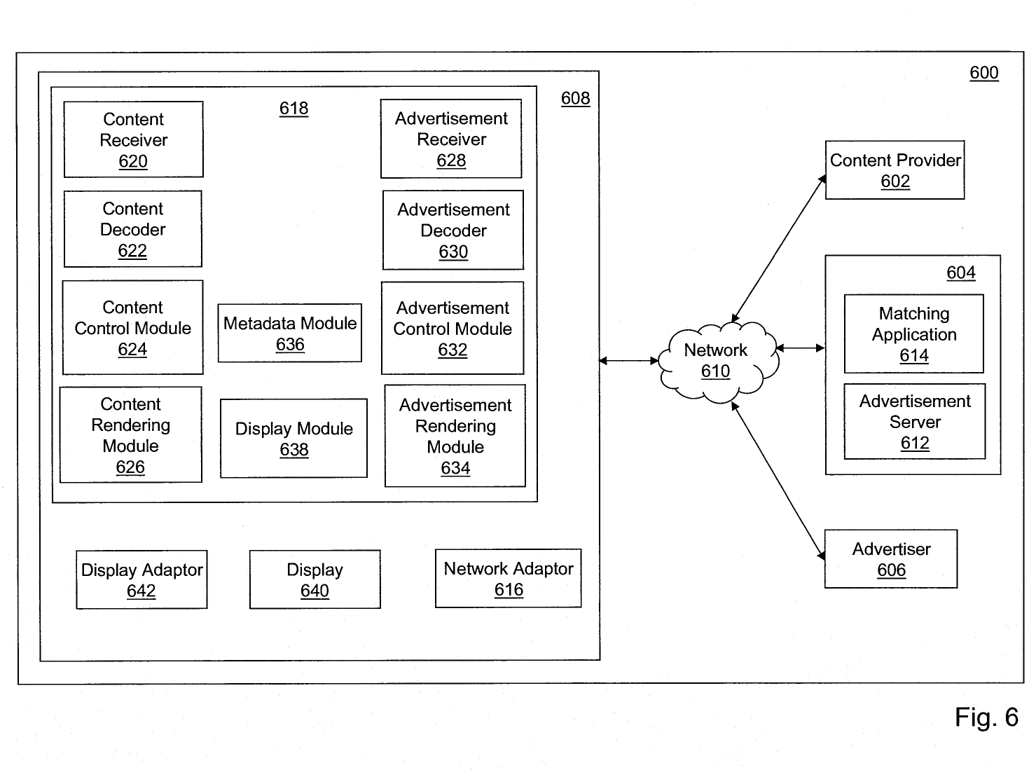

With reference to FIG. 3, user device 102 may include a display 300, a display module 301, an input interface 302, a communication interface 304, a memory 306, a processor 308, a media management application 310, and a media player application 324. Different and additional components may be incorporated into user device 102. For example, user device 102 may include speakers for presentation of audio media content. Display 300 receives information from display module 301, and presents information to a user of user device 102 as known to those skilled in the art. Display module 301, which is described in more detail with reference to FIGS. 6-8, can be used to provide one or more video streams to display 300. Display 300 may be a thin film transistor display, a light emitting diode display, a liquid crystal display, or any of a variety of different displays known to those skilled in the art now or in the future.

Input interface 302 provides an interface for receiving information from the user for entry into user device 102 as known to those skilled in the art. Input interface 302 may use various input technologies including, but not limited to, a keyboard, a pen and touch screen, a mouse, a track ball, a touch screen, a keypad, one or more buttons, etc. to allow the user to enter information into user device 102 or to make selections presented in a user interface displayed on display 300. Input interface 302 may provide both an input and an output interface.

Communication interface 304 provides an interface for receiving and transmitting data between devices using various protocols, transmission technologies, and media as known to those skilled in the art. User device 102 may have one or more communication interfaces that use the same or different protocols, transmission technologies, and media.

Memory 306 is an electronic holding place or storage for information so that the information can be accessed by processor 308 as known to those skilled in the art. User device 102 may have one or more memories that use the same or a different memory technology. User device 102 also may have one or more drives that support the loading of a memory media such as a CD or DVD or ports that support connectivity with memory media such as flash drives.

Processor 308 executes instructions as known to those skilled in the art. Processor 308 may be implemented in hardware, firmware, software, or any combination of these methods. Processor 308 executes an instruction, meaning that it performs the operations called for by that instruction. Processor 308 operably couples with display 300, with input interface 302, with communication interface 304, and with memory 306 to receive, to send, and to process information. Processor 308 may retrieve a set of instructions from a permanent memory device and copy the instructions in an executable form to a temporary memory device that is generally some form of RAM. User device 102 may include a plurality of processors that use the same or a different processing technology.

Media player application 324 performs operations associated with presentation of media to a user. The operations may be implemented using hardware, firmware, software, or any combination of these methods. With reference to the exemplary embodiment of FIG. 3, media player application 324 is implemented in software stored in memory 306 and accessible by processor 308 for execution of the instructions that embody the operations of media player application 324. Media player application 324 may be written using one or more programming languages, assembly languages, scripting languages, etc.

Media management application 310 performs operations associated with the presentation of content to be presented with a media stream to the user of user device 102. Media management application 310 manages communication between user device 102, which may include a set-top box, and media stream source device 104, advertisement controller device 106, and advertiser device 107 and transmits a media stream and an ad stream, through media player application 324 to display 300. The media stream may be transmitted based on a live broadcast stream or an on-demand stream. The operations may be implemented using hardware, firmware, software, or any combination of these methods. With reference to the exemplary embodiment of FIG. 3, media management application 310 is implemented in software stored in memory 306 and accessible by processor 308 for execution of the instructions that embody the operations of media management application 310. Media management application 310 may be written using one or more programming languages, assembly languages, scripting languages, etc. Media management application 310 may integrate with or otherwise interact with media player application 324.

Media management application 310 may include a plurality of modules that may be fully or partially integrated or execute independently. In an exemplary embodiment, the plurality of modules include an ad stream receiver 312, a media stream receiver 314, a media mixing module 316, a media monitoring module 318, an audience data module 320, and an interactive communication module 322. Ad stream receiver 312 receives an ad stream from media insertion module 224 of advertisement controller device 106. Media stream receiver 314 receives a media stream from media stream source device 104. Media mixing module 316 receives both the ad stream from ad stream receiver 312 and the media stream from media stream receiver 314. If only a media stream is received, media mixing module 316 transmits the media stream directly into media player application 324. When media mixing module 316 receives both an ad stream and a media stream, media mixing module 316 may present both streams to the display as picture-in-picture in a manner known to those skilled in the art, may mix them into one stream, or may switch between the media stream and the ad stream according to instructions received with the ad stream received from media insertion module 224. The instructions may contain data about the location of the ad stream within the media content, the size of the ad on display 300, the timing and duration of the ad exposure, etc. For example, the instructions may be included in a header of the received ad stream. In another exemplary embodiment, the instructions may be included in a separate file sent to user device 102.

Media monitoring module 318 is triggered on by a connection to the ad stream and the actual presentation of the ad stream to the display 300. Media monitoring module 318 is triggered off by either a disconnection from the ad stream, a disconnection to display 300 while the advertisement is presented, or by ending of the ad stream, as indicated by receiving a control byte signal located in a trailer of the ad stream. In an exemplary embodiment, media monitoring module 318 only sends an exposure confirmation to billing module 226 when media monitoring module 318 turns off as a result of ending of the ad stream. Billing module 226 uses the exposure confirmation to bill the advertiser for the exposure. Media monitoring module 318 may also calculate a time duration, a start time, and/or a stop time that the user of user device 102 is connected to the ad stream. For example, media monitoring module 318 may capture a start signal and an end signal of the ad stream that include a start control byte and an end control byte, respectively. Media monitoring module 318 transmits the timing information to billing module 226 of advertisement controller device 106. Billing module 226 also may calculate whether the user was exposed to the content and ad for a sufficient time period to bill the advertiser for the exposure.

Media monitoring module 318 tracks each ad from the moment it is delivered to user device 102 until it is presented to the user using display 300. Media monitoring module 318 treats each ad separately. If a screen-saver starts or the user minimizes the window of media player application 324 while a commercial is running, media monitoring module 318 switches itself to a “pause” status to indicate that the user is not viewing the ad. Media monitoring module 318 receives an indicator of the screen-saver start from an operating system of user device 102. Media monitoring module 318 receives an indicator of the window minimization from media player application 324. Media monitoring module 318 further receives an indication that a user is skipping a commercial by forwarding the play of the media using media player application 324. Media monitoring module 318 recognizes events indicating that the user is not viewing the advertisement to correctly calculate the timing information associated with the user's exposure to the ad stream.

When presentation of the ad is stopped, the exposure report is sent to advertisement controller device 106. If an ad is presented more than once, for example as a result of seeking backward, the exposure report is sent only after the first exposure. If media monitoring module 318 fails to send the exposure report at the end of the presentation of the ad stream, media monitoring module 318 stores the report in a stream accessible by memory 306 of user device 102. Media monitoring module 318 sends the exposure report the next time the user operates media player application 324 at user device 102.

Audience data module 320 contains data that the user of user device 102 provides to audience information module 222 of advertisement controller device 106. For example, the data may contain the operating system and browser language of user device 102, the user age, gender, and other data that by the user's consent may be gathered and presented to advertisers.

Interactive communication module 322 creates an advertiser selection area, or overlay, on display 300 which the user of user device 102 may select using input interface 302. The selection may hyperlink the user directly to advertiser device 107. The hyperlink may be to the advertiser's website or other interactive system provided by advertiser device 107. Interactive communication module 322 may send an indication of the selection by the user to billing module 226 of advertisement controller device 106 to provide for billing according to the price for an interactive communication that results from the ad's exposure.

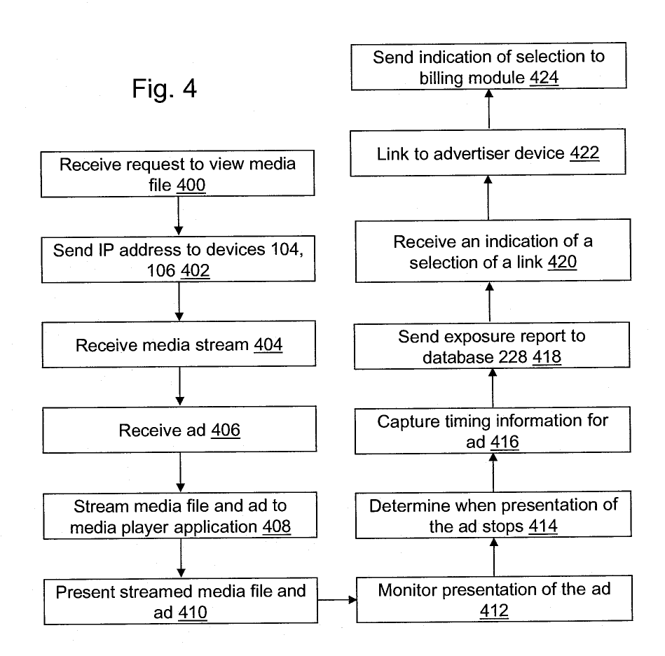

With reference to FIG. 4, exemplary operations associated with media management application 310 of FIG. 3 are described. Additional, fewer, or different operations may be performed, depending on the embodiment. The order of presentation of the operations is not intended to be limiting. In an operation 400, media management application 310 receives a request from the user of user device 102 to view a media stream. For example, the user may select a media stream by entering or selecting a link to media stream source device 104 using a variety of methods known to those skilled in the art.

In an operation 402, the IP address of the user device 102 is sent to media stream source device 104 and/or the audience information module 222 of advertisement controller device 106 to enable the targeted ad insertion to the user while viewing the selected media stream. In an operation 404, the selected media stream is received by media stream receiver 314. In an operation 406, an ad stream selected by media insertion module 224 of advertisement controller device 106 is received by ad stream receiver 312. The ad stream is selected based on information provided by audience data module 320 of user device 102 to media insertion module 224 of advertisement controller device 106.

In an operation 408, the received media stream and the received ad stream are streamed from media mixing module 316 to media player application 324. In an operation 410, media player application 324 presents the streamed media stream and ad stream on display 300. For example, the user may select a play button or the streamed media stream and ad stream may automatically start playing as they are received at user device 102.

In an operation 412, media monitoring module 318 monitors presentation of the ad stream. Media monitoring module 318 recognizes the end of the ad stream, as indicated by the control byte in the trailer of the stream, to send an exposure confirmation to billing module 226. Events indicating that the user is not viewing the advertisement are identified to prevent erroneous confirmation and to correctly calculate the timing information associated with the user's exposure to the ad stream. In an operation 414, media monitoring module determines when presentation of the ad stream stops. When presentation of the ad stream stops, media monitoring module 318 makes sure that the control byte signaling the ad stream end is received and captures the timing information in an operation 416. Media monitoring module sends an exposure report including the exposure confirmation and/or timing information to database 228 of advertisement controller device 106 in an operation 418.

In an operation 420, media monitoring module receives an indication of a selection of a link. In an operation 422, interactive communication module 322 links the user directly to advertiser device 107 or another link specified by the advertiser. In an operation 424, interactive communication module 322 sends an indication of the selection by the user to billing module 226 of advertisement controller device 106 in the exposure report or in another report.

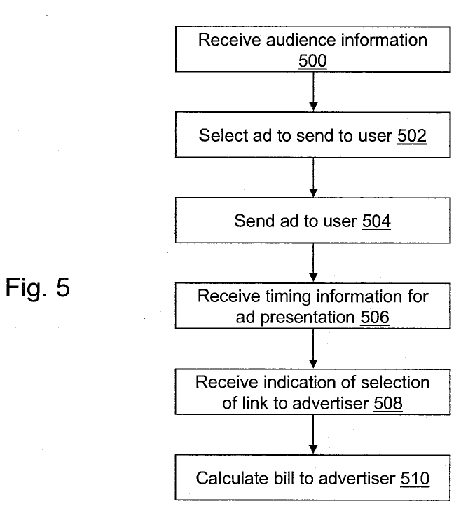

With reference to FIG. 5, exemplary operations associated with advertisement control application 210 of FIG. 2 are described. Additional, fewer, or different operations may be performed, depending on the embodiment. The order of presentation of the operations is not intended to be limiting. In an operation 500, audience information module 222 of advertisement control application 210 receives audience information from the user of user device 102. The audience information module may include the IP address of user device 102, the media that the user is requesting, the time the user connected to media stream source device 104 to request the media, other data that the audience (user at user device 102) may provide, etc. The audience information may be transmitted to the appropriate modules of the plurality of modules of advertisement control application 210. For example, the requested media and the IP address may be transmitted to media insertion module 224. In an operation 502, media insertion module 224 selects the ad stream to send to the user. For example, media insertion module 224 may include a table describing conditions for matching ads with content, a targeted audience, available media channels, insertion timing and duration, and media types. In an operation 504, media insertion module 224 sends the selected ad stream to the user at user device 102 at the correct time according to the criteria specified in campaign builder module 214.

In an operation 506, timing information associated with the user's viewing of the ad stream is received from user device 102. The timing information may be stored in database 228 for the creation of rating and billing data. The rating and viewing data also may be transmitted to billing module 226 to calculate the correct billing to an advertiser in an operation 510. Billing module 226 may receive pricing information from media directory 230 and actual activities (connection to specific media, actual rating) from database 228. In an operation 508, an indication of selection of a hyperlink to an advertiser by the user at user device 102 is received. Billing module 226 may include the indication of interactive communication between a user and advertiser device 107 in the billing calculation of operation 510. In an exemplary embodiment, a bill can be calculated for the advertiser regardless of whether the advertisement contains a selection area, and/or regardless of whether the user selects the selection area.

With reference to FIG. 6, a block diagram of an advertising system 600 in which content data streams and advertising data streams are combined and/or synchronized is shown in accordance with an exemplary embodiment. Advertising system 600 includes a content provider 602, an advertisement manager 604, an advertiser 606, and a user device 608. In an exemplary embodiment, content provider 602 can include any of the functionality/components of media stream source device 104 described with reference to FIG. 1. Advertisement manager 604 can include any of the functionality/components of advertisement controller device 107 described with reference to FIGS. 1, 2, and 5. Advertiser 606 can include any of the functionality/components of advertiser device 107 described with reference to FIG. 1. Similarly, user device 608 can include any of the functionality/components of user device 102 described with reference to FIGS. 1, 3, and 4.

Content provider 602 can include one or more computing devices (i.e., computers, servers, databases, etc.) adapted to provide a content data stream in response to a content request. Content provider 602 can also include one or more users of the one or more computing devices. Advertiser 606 can include one or more computing devices adapted to provide advertisements. Advertiser 606 can also include one or more users of the one or more computing devices. Advertising manager 604 can also include one or more computing devices. In an exemplary embodiment, operations performed by advertising manager 604 can be automated. Alternatively, advertising manager 604 may include one or more users. User device 608 can be a laptop, personal computer, cellular telephone, portable gaming unit, personal digital assistant, or any other communication device. Any or all of content provider 602, advertisement manager 604, advertiser 606, and user device 608 can communicate with one another through a network 610. Network 610 can be a local area network (LAN), a wide area network (WAN) such as the Internet, a telecommunications network, or any other medium through which information can be exchanged. Alternatively, any or all of content provider 602, advertisement manager 604, advertiser 606, and user device 608 can be in direct communication with one another. For example, advertisement manager 604 may be incorporated into content provider 602 or connected to content provider 602 through a cable or other connection.

Content provider 602 can provide requested content to user device 608 in the form of a content data stream. The content data stream can be streamed to user device 608 through network 610 by any method known to those skilled in the art. The requested content (or media) can include video content, audio content, textual content, graphical content, or any other type of content which can be streamed through network 610. Content provider 602 can also provide content data to advertisement manager 604. The content data may include a uniform resource locator (URL) at which the content can be requested and/or accessed, a language of the content, a genre of the content, a content type (i.e., video, music, text, etc.), a target audience of the content based on gender, age, demographics, etc., location(s) at which the content is available to users, prices for buying air time during presentation of the content, a timeline specifying time slots during which advertisements can be placed into the content, and/or any other information regarding the content or content provider 602.

The content data provided by content provider 602 may also include timing information regarding the content. The timing information can include a duration of the content, a date and/or time at which the content is made available to users, a date and/or time at which the content is made unavailable to users, specific days and/or times when the content is available, and/or a broadcast schedule for the content. The content data may further include special terms such as a prohibition against the use of advertisements directed toward sexual or other adult content. In an exemplary embodiment, content provider 602 can provide the content data to advertisement manager 604 through a web page. Alternatively, content provider 602 can provide the content data by any other method. The content data can be stored within a database or other storage mechanism of advertisement manager 604. The database can be a standard database such as a Microsoft (Redmond, Wash.) structured query language (MS SQL) database, a my structured query language (MySQL) database, etc.

Advertiser 606 can provide advertisement data to advertisement manager 604. The advertisement data can include data describing the advertisement and/or content criteria describing content into which advertiser 606 is willing to place the advertisement. In an exemplary embodiment, the advertisement data can correspond, at least in part, to the content data provided by content provider 602 such that advertisement manager 604 can efficiently compare the advertisement data to the content data. As an example, the advertisement data may include a language of the advertisement such that advertisement manager 604 can locate content of the same language. The advertisement data can also include a desired genre of the content, a desired language of the content, a desired target audience of the content, a desired location at which the content is to be presented, a desired content type, a maximum price which advertiser 606 is willing to pay to have the advertisement placed into content, an advertisement type (i.e., video, music, text, graphics, link, etc.), a duration of the advertisement, etc. In an exemplary embodiment, advertiser 606 can provide the advertisement data to advertisement manager 604 through a web page. Alternatively, advertiser 606 can provide the advertisement data by any other method. The advertisement data can be stored within the database or other storage mechanism of advertisement manager 604 used to store the content data. Alternatively, a different storage mechanism may be used.

In an exemplary embodiment, advertiser 606 can also upload the advertisement to an advertisement server 612 of advertisement manager 604. The advertisement can be uploaded as an advertisement data stream such that advertisement server 612 can stream the advertisement to user device 608. Advertisement server 612 can include a database, one or more hard disks, or any other storage mechanism(s) for storing the advertisement. If the received advertisement is a video or audio advertisement, advertisement manager 604 can calculate a duration of the received advertisement.

Advertisement manager 604 can also include a matching application 614 configured to match advertisements to content based on the content data supplied by content provider 602 and the advertisement data supplied by advertiser 606. For each advertisement submitted by advertiser 606, matching application 614 can be used to generate a list of content which matches the content criteria set forth in the advertisement data corresponding to the advertisement. In an exemplary embodiment, the list of content may only include content in which the advertisement can be placed based on the parameters set forth in the content data. For example, if the advertisement is for alcohol, content in which alcoholic advertisements are prohibited may not be included in the list of content. Advertisement manager 604 can provide advertiser 606 with the list of content, including any or all of the content data corresponding to the content in the list of content.

In an exemplary embodiment, advertiser 606 can review the list of content provided by advertisement manager 604 and select one or more pieces of content in which advertiser 606 would like to purchase air time. Advertiser 606 can also indicate one or more specific locations within the selected content during which advertiser 606 would like to advertise. In an exemplary embodiment, the one or more specific locations may be represented as one or more presentation times at which the advertisement is to be presented. The presentation times can be based on an elapsed time of the content. For example, the timeline for a piece of content may indicate that there are thirty second advertising windows at the beginning of the content, in the middle of the content, and at the end of the content. Even though middle window may cost more, advertiser 606 may choose to purchase air time during the middle of the content to increase the likelihood that the advertisement will be viewed. Advertiser 606 can provide content selections and/or desired presentation times within content selections to advertisement manager 604 through a web site or by any other method. Advertiser 606 can also provide advertisement manager 604 with an advertising budget. As an example, advertiser 606 may specify that advertisement A should be presented at a first location of content A no more than 10,000 times such that a given budget is not exceeded. Similarly, advertiser 606 may specify that advertisement B should be presented at a second location of content A no more than 1000 times. In alternative embodiments, advertising budgets may be specified by any other method and/or according to any other criteria. Advertisement manager 604 can ensure that the budget of advertiser 606 is not exceeded.

A user can use user device 608 to request content from content provider 602 by any method known to those of skill in the art. In an exemplary embodiment, content provider 602 can include a web site configured to receive content requests. Alternatively, content requests may be received by advertisement manager 604. User device 608 includes a network adaptor 616 configured to allow user device 608 to communicate through network 610. Network adaptor 616 can be a communication card, a modem, or any other network communication module(s) known to those of skill in the art. Upon receiving a content request from user device 608, content provider 602 can query user device 608 to determine whether user device 608 includes a data stream application 618. If user device 608 does not include data stream application 618, the user can be prompted to download data stream application 618 prior to receiving a content data stream corresponding to the requested content. Alternatively, user device 608 may be queried and/or prompted by advertising manager 604. If data stream application 618 is not installed on user device 608, user device 618 can download and install data stream application 618.

In an exemplary embodiment, data stream application 618 can be used to combine and synchronize a content data stream and an advertisement data stream. Data stream application 618 can be any type of computer program capable of receiving, combining, synchronizing, and/or displaying data streams. For example, data stream application 618 may be similar to an ActiveX program. Data stream application 618 can include a content receiver 620, a content decoder 622, a content control module 624, a content rendering module 626, an advertisement receiver 628, an advertisement decoder 630, an advertisement control module 632, an advertisement rendering module 634, a metadata module 636, and a display module 638. In alternative embodiments, data stream application 618 may include additional, fewer, or different components.

In an exemplary embodiment, data stream application 618 can use network adaptor 616 communicate through network 610. Data stream application 618 can notify advertisement manager 604 when user device 608 requests content from content provider 602. Data stream application 618 can also provide advertisement manager 604 with viewer data regarding user device 608. The viewer data can include an Internet protocol (IP) address of user device 608, a uniform resource locator (URL) corresponding to the requested content, the language of a browser of user device 608, the language of a keyboard of user device 608, information regarding the user of user device 608, etc. Advertisement manager 604 can use the URL corresponding to the requested content to identify the content and content provider 602. Once the content is identified, advertisement manager 604 can access the content information provided by content provider 602 to ensure that user device 608 is operating in the same language as the requested content, that user device 608 is in a location where the requested content is being provided, that the user and/or user device satisfy any criteria of advertiser 606, etc. Advertising manager 604 can also identify any advertisements which are to be provided during the requested content.

Content provider 602 can stream a content data stream corresponding to the requested content to user device 608. Content receiver 620 can receive the content data stream. In an exemplary embodiment, content receiver 620 may receive the content data stream in the form of transport packets. Content receiver 620 can extract elementary packets from the transport packets such that the content data stream can be decoded. Content decoder 622 can receive the elementary packets from content receiver 620. If the requested content is video content, content decoder 622 can convert the elementary packets into a video content data stream. Similarly, if the requested content is audio content, content decoder 622 can convert the elementary packets into an audio content data stream. Content rendering module 626 can receive the video/audio/etc. content data stream from content decoder 622, and can convert the content data stream into an uncompressed content data stream. Content rendering module 626 can provide the uncompressed content data stream to display module 638.

In an exemplary embodiment, display module 638 may include a first input adapted to receive the uncompressed content data stream. Display module 638 can provide the uncompressed content data stream to a display adaptor 642, and display adaptor 642 can convert the uncompressed content data stream into an analog content data stream. Display adaptor 642 can also provide the analog content data stream to a display 640 of user device 608. In an exemplary embodiment, display module 638 can receive, at a second input, an uncompressed advertisement data stream from advertisement rendering module 634. Display module 638 can combine the uncompressed advertisement data stream and the uncompressed content data stream into a single data stream based on advertisement size data received in advertisement metadata. Display module 638 can provide the single data stream to display adaptor 642 such that the single data stream can be converted into an analog data stream and presented on display 640. As such, the content and the advertisement can be displayed simultaneously. In an alternative embodiment, the uncompressed advertisement data stream and the uncompressed content data stream may not be combined into a single data stream. In another alternative embodiment, the analog data stream may be provided to speakers, an external monitor, a projector, or any other device such that the user can experience the requested content.

As described above, advertisement manager 604 can identify an advertisement which is to be presented through user device 608 along with the requested content. Advertising manager 604 can send advertisement metadata corresponding to the advertisement to metadata module 636 of data stream application 618. The metadata can include any information related to the advertisement, including a duration of the advertisement, an advertisement type, a presentation time at which the advertisement is to be presented, how the advertisement is to be presented relative to the content, etc. Display module 638 can use an internal clock of user device 608, a clock associated with the content, and/or any other timing mechanism to monitor an elapsed time of the content. In an exemplary embodiment, the advertisement metadata can indicate one or specific elapsed times at which the advertisement is to be presented. As such, monitoring the elapsed time allows data stream application 618 to present the advertisement at the appropriate time relative to the content. If the content is paused or otherwise interrupted, display module 638 can also pause the elapsed time such that the elapsed time remains accurate.

When the appropriate amount of time has elapsed since the start of the content, the advertisement can be presented to the user of user device 608. In an exemplary embodiment, data stream application 618 can request the advertisement from advertisement manager 604 when the elapsed time of the content stream is equal to the designated elapsed time for presenting the advertisement. Alternatively, data stream application 618 can request the advertisement at any other time prior to the designated elapsed time for presenting the advertisement. In another alternative embodiment, data stream application 618 may request the advertisement directly from advertiser 606. In an exemplary embodiment, the advertisement can be stored at advertisement server 612, and advertisement server 612 can stream the requested advertisement to user device 608. Alternatively, the advertisement may be stored at a proxy server in a content distribution network, and advertisement server 612 may direct the proxy server to stream the advertisement to user device 608. In an alternative embodiment, elapsed time may not be used to determine when the advertisement is to be presented. As an example, time remaining in the content, random timing, etc. may be used to determine when the advertisement is to be presented. Alternatively, data stream application 618 may use any other method of determining when to present the advertisement.

The advertisement data stream can be received by advertisement receiver 628. Advertisement receiver 628 can receive the advertisement data stream in the form of transport packets. Advertisement receiver 628 can extract elementary packets from the transport packets such that the advertisement data stream can be decoded. Advertisement decoder 630 can receive the elementary packets from advertisement receiver 628. If the advertisement is a video advertisement, advertisement decoder 630 can convert the elementary packets into a video advertisement data stream. Similarly, if the advertisement is an audio advertisement, advertisement decoder 630 can convert the elementary packets into an audio advertisement data stream. Advertisement rendering module 634 can receive the video/audio/etc. advertisement data stream from advertisement decoder 630, and can convert the advertisement data stream into an uncompressed advertisement data stream.

In an exemplary embodiment, display module 638 can determine, based on advertisement metadata received by metadata module 636, whether the advertisement is to be presented as a full screen advertisement displayed in place of the content (i.e., during a commercial break), a partial screen advertisement displayed at the same time as at least a portion of the content, an overlay to be presented over the top of the content, etc. If the advertisement is a full screen advertisement, display module 638 can send a pause command to content provider 602 such that the content is paused. Advertisement rendering module 634 can provide the uncompressed advertisement data stream to display module 638. Display module 638 can provide the uncompressed advertisement data stream to display adaptor 642, and display adaptor 642 can cause the advertisement to be presented on display 640 to the exclusion of the paused content. When the advertisement is finished, display module 638 can send a resume command to content provider 602 such that streaming of the content data stream resumes. Display module 638 can also provide display adaptor 642 with the uncompressed content data stream from content rendering module 626 such that the content is presented on display 640.

If the advertisement is to be presented simultaneously with the content, display composer 638 can send a notification to content control module 624. Content control module 624 can crop the content data stream such that a portion of the content data stream and the advertisement data stream can be displayed simultaneously. In an exemplary embodiment, the advertisement metadata can include the size of the advertisement, and content control module 624 can crop the content data stream based on the size of the advertisement. Display module 638 can combine the uncompressed advertisement data stream and the cropped content data stream into a single data stream, and provide the single data stream to display adaptor 642. Alternatively, content control module 624 may re-size the content data stream such that the a smaller version of the entire content data stream can be viewed simultaneously with the advertisement through display 640.

In an alternative embodiment, the advertisement may be overlaid on top of the content. Transparency may be used such that at least a portion of the content is visible through the advertisement. Advertisement control module 632 can be used to apply transparency to the advertisement by any method known to those of skill in the art. Alternatively, transparency may be applied to the advertisement by advertiser 606 and/or advertising manager 604. Alternatively, transparency may not be applied to the advertisement.

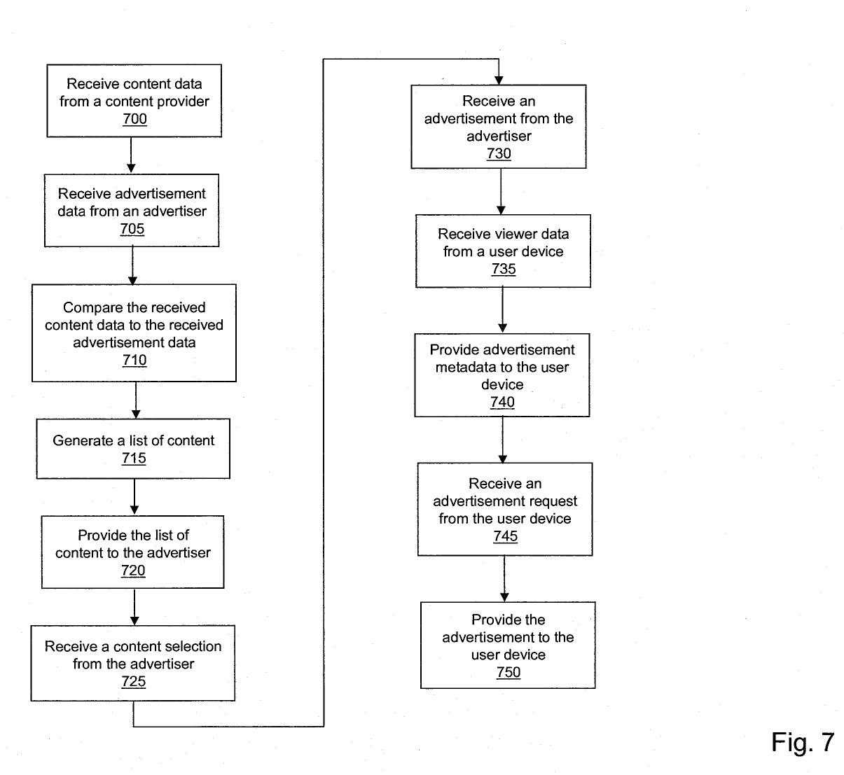

With reference to FIG. 7, a flow diagram illustrating operations performed by advertisement manager 604 of FIG. 6 is shown in accordance with an exemplary embodiment. In alternative embodiments, additional, fewer, or different operations may be performed. The use of a flow diagram is not meant to be limiting with respect to the order of operations performed. In an operation 700, the advertisement manager receives content data from a content provider. The content data can be information corresponding to a single piece of content in which advertisements may be placed. Alternatively, the content data may correspond to a plurality of pieces of content. In an operation 705, the advertising manager receives advertisement data from an advertiser. The advertisement data can be information corresponding to a single advertisement which the advertiser would like to place into content. In an exemplary embodiment, the received advertisement data can correspond at least in part to the received content data. For example, if the content data indicates the a target audience for the content, the advertisement data may include a desired target audience for the advertisement. The advertisement data may also include advertisement metadata including specific characteristics of the advertisement. The advertisement metadata may include a duration of the advertisement, how the advertisement is to be displayed relative to content (i.e., separately, simultaneously, overlaid, etc.), a size of the advertisement, etc.

In an operation 710, the advertisement manager compares the received content data to the received advertisement data. The comparison can be used to match an advertisement to one or more pieces of content with which the advertisement is compatible. In an operation 715, the advertisement manager generates a list of content. In an exemplary embodiment, the list of content can include content in which a given advertisement can be placed based on content criteria included in the advertisement data and parameters included in the content data. In an operation 720, the advertisement manager can provide the list of content to the advertiser.

The advertiser can review the list of content and any content data associated with the content to determine within which piece(s) of content the advertiser would like to advertise. In an operation 725, the advertisement manager receives a content selection from the advertiser. The content selection can identify one or more pieces of content within which the advertiser would like to place an advertisement. The content selection can also identify specific locations within the one or more pieces of content where the advertisement is to be placed. The specific locations may be conveyed as presentation times which correspond to elapsed times of the content. The content selection may also include any other advertisement metadata.

In an operation 730, the advertisement manager receives an advertisement from the advertiser. The advertisement manager can store the advertisement in a local database, in a remote database, on one or more hard discs, or in any other storage location. In an operation 735, the advertisement manager receives viewer data from a user device. In an exemplary embodiment, the viewer data can be sent from data stream application 618 described with reference to FIG. 6, and can include the IP address of the user device, the URL of the content requested by the user device, and/or the language of the user device. In one embodiment, the advertisement manager can compare the received view data to the received advertisement data to ensure that any criteria of the advertiser are met. In an operation 740, the advertisement manager provides advertisement metadata to the user device. The advertisement metadata can be used by the user device to determine when and how the advertisement is to be placed in the content.

In an operation 745, the advertisement manager receives an advertisement request from the user device. The advertisement request can be sent by data stream application 618 at the presentation time (i.e., the time when the advertisement is to be presented on the user device). Alternatively, the advertisement request can be sent to the advertisement manager at any time prior to the presentation time of the advertisement. In an operation 750, the advertisement manager provides the advertisement to the user device. The advertisement can be provided in the form of an advertisement data stream such that the user device can combine and/or synchronize the advertisement with the content. In an alternative embodiment, the advertisement may be provided to the user device by the advertiser.

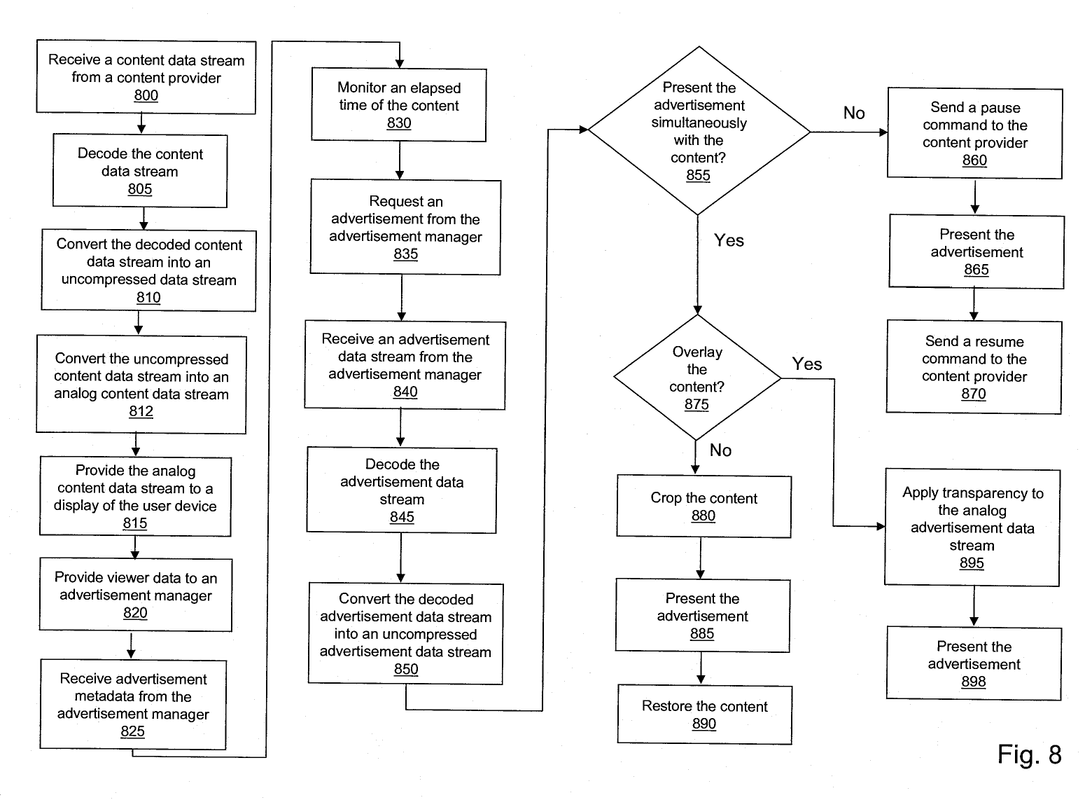

With reference to FIG. 8, a flow diagram illustrating operations performed by a data stream application is shown in accordance with an exemplary embodiment. In alternative embodiments, additional, fewer, or different operations may be performed. The use of a flow diagram is not meant to be limiting with respect to the order of operations performed. In an exemplary embodiment, data stream application can be a computer program located on a user device. Alternatively, the data stream application may be a combination of software and hardware. In an operation 800, the data stream application receives a content data stream from a content provider. The content data stream may be requested by the data stream application, or any other hardware/software on the user device.

In an operation 805, the data stream application decodes the received content data stream. The content data stream can be decoded by any method known to those skilled in the art. In an operation 810, the data stream application converts the content data stream into an uncompressed content data stream. In an operation 812, the data stream application, coupled with display adaptor hardware, converts the uncompressed content data stream into an analog content data stream such that the requested content can be experienced by a user of the user device. In an operation 815, the data stream application provides the analog content data stream to a display of the user device. In an exemplary embodiment, the display can be a computer monitor or screen such that the user can view the requested content. In another exemplary embodiment, the data stream application can cause a display adaptor to receive the analog content data stream. In alternative embodiments, the content data stream can be conveyed to the user by any method.

In an operation 820, the data stream application provides viewer data to an advertisement manager such that the advertisement manager is able to identify one or more advertisements to be presented during the requested content. The viewer data can include any information regarding the requested content, the content provider, the user device, and/or the user of the user device. In an operation 825, the data stream application receives advertisement metadata from the advertisement manager. The data stream application can use the advertisement metadata to determine when and how an advertisement is to be presented relative to the content.

In an operation 830, the data stream application monitors an elapsed time of the content. The elapsed time can refer to actual uninterrupted time during which the user has experienced the requested content. The data stream application can use the elapsed time to determine when to present the advertisement. In an operation 835, the data stream application requests an advertisement from the advertisement manager. The advertisement may be requested when the elapsed time equals a designated presentation time for presenting the advertisement. Alternatively, the advertisement may be requested any time prior to the designated presentation time.

In an operation 840, the data stream application receives an advertisement data stream from the advertisement manager. In an operation 845, the data stream application decodes the advertisement data stream. The advertisement data stream can be decoded by any method known to those skilled in the art. In an operation 850, the data stream application converts the decoded advertisement data stream into an uncompressed advertisement data stream, and provides the uncompressed advertisement data stream to a display adaptor. The display adaptor can convert the uncompressed advertisement data stream into an analog data stream such that the advertisement can be presented to the user.

In an operation 855, the data stream application determines whether the advertisement is to be presented simultaneously with the content. If the advertisement is not to be presented simultaneously with the content, the data stream application sends a pause command to the content provider in an operation 860. In an operation 865, the data stream application presents the advertisement to the user. The advertisement can be presented as video through the display of the user device, as audio through speakers of the user device, as text or graphics through the display of the user device, etc. In an exemplary embodiment, the data stream application can present the advertisement by causing the display adaptor to receive the uncompressed advertisement data stream. The input of the display adaptor which receives the uncompressed advertisement data stream can be the same input which received the uncompressed content data stream, or a different input depending on the embodiment. In an operation 870, the data stream application sends a resume (i.e., play) command to the content provider such that the content resumes after the advertisement is presented.

If the advertisement is to be presented simultaneously with the content, the data stream application determines whether the advertisement is to overlay the content in an operation 875. If the advertisement is not going to overlay the content, the data stream application crops the content in an operation 880. The content can be cropped using any method known to those of skill in the art. The amount by which the content is cropped can be based on a size of the advertisement. For example, if the advertisement is to be presented on an upper one half of the display, the data stream application can crop the content by 50% such that only the lower one half of the content is visible. The size and/or position of the advertisement may be included in the advertisement metadata received in operation 825. In an operation 885, the data stream application presents the advertisement. The advertisement can be presented simultaneously with a portion of the content that was not cropped to accommodate the advertisement. In an exemplary embodiment, the uncompressed (cropped) content data stream can be received by a first input of a display module, and the uncompressed advertisement data stream can be received by a second input of the display module. Alternatively, both the uncompressed (cropped) content data stream and the uncompressed advertisement data stream may be received through the same input of the display module. In another exemplary embodiment, the advertisement is presented by combining the uncompressed (cropped) content data stream with the uncompressed advertisement data stream into a single data stream. The single data stream can be provided to the display adaptor, which can convert the single data stream into an analog data stream for presentation on the display. Alternatively, two or more data streams may be provided to the display adaptor. In an operation 890, the data stream application restores the content such that the content is no longer cropped. As such, the user can experience the content in full after the advertisement is presented. The content can be restored by any method known to those of skill in the art. In an alternative embodiment, the content may be resized instead of cropped. As such, the user can experience a smaller version of the entire content while the advertisement is being presented.

If the advertisement is to overlay the content, the data stream application applies transparency to the analog advertisement data stream in an operation 895. The degree of transparency, which can be varied such that the visibility of the content underlying the advertisement is increased or decreased, may be indicated in the advertisement metadata received in operation 825. The data stream application can apply the transparency by any method known to those skilled in the art. In an alternative embodiment, the advertisement data stream received in operation 840 may include transparency such that the data stream application does not apply transparency. In an operation 898, the advertisement is presented. In an exemplary embodiment, the advertisement is presented by causing the display adaptor to receive the at least partially transparent uncompressed advertisement data stream. The display adaptor can also receive the uncompressed content data stream such that the content and the advertisement are combined and displayed simultaneously. The display adaptor can receive the uncompressed content data stream and the uncompressed advertisement data stream as a single data stream, or as two distinct data streams, depending on the embodiment.

The word “exemplary” is used herein to mean serving as an example, instance, or illustration. Any aspect or design described herein as “exemplary” is not necessarily to be construed as preferred or advantageous over other aspects or designs. Further, for the purposes of this disclosure and unless otherwise specified, “a” or “an” means “one or more.”

The exemplary embodiments may be implemented as a method, apparatus, or article of manufacture using standard programming and/or engineering techniques to produce software, firmware, hardware, or any combination thereof to control a computer to implement the disclosed embodiments. The term “computer readable medium” can include, but is not limited to, magnetic storage devices (e.g., hard disk, floppy disk, magnetic strips, . . . ), optical disks (e.g., compact disk (CD), digital versatile disk (DVD), . . . ), smart cards, flash memory devices, etc. Additionally, it should be appreciated that a carrier wave can be employed to carry computer-readable media such as those used in transmitting and receiving electronic mail or in accessing a network such as the Internet or a local area network (LAN). The network access may be wired or wireless.

The foregoing description of exemplary embodiments of the invention have been presented for purposes of illustration and of description. It is not intended to be exhaustive or to limit the invention to the precise form disclosed, and modifications and variations are possible in light of the above teachings or may be acquired from practice of the invention. The functionality described may be implemented in a single executable or application or may be distributed among modules that differ in number and distribution of functionality from those described herein. Additionally, the order of execution of the functions may be changed depending on the embodiment. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A method of presenting an advertisement comprising:
receiving a content data stream from a content provider;
providing the received content data stream to a first input of a display module such that the received content data stream is presented on a display;
receiving advertisement metadata corresponding to an advertisement, wherein the advertisement metadata comprises a presentation time for the advertisement;
receiving an advertisement data stream corresponding to the advertisement; and
providing the received advertisement data stream to a second input of the display module such that the received advertisement data stream is presented on the display at the presentation time.

2. The method of claim 1, wherein the second input comprises the first input.

3. The method of claim 1, wherein the presentation time comprises an elapsed time of the received content data stream.

4. The method of claim 1, further comprising:
sending a pause command to the content provider such that presentation of the content data stream is paused, wherein the paused content data stream is not presented on the display;
providing the received advertisement data stream to the second input of the display module such that the received advertisement data stream is presented on the display while the content data stream is paused; and
sending a resume command to the content provider such that presentation of the content data stream is resumed.

5. The method of claim 1, further comprising cropping the received content data stream based on a size of the advertisement such that the received advertisement data stream and at least a portion of the received content data stream are simultaneously presented on the display.

6. The method of claim 5, wherein the advertisement metadata further comprises the size of the advertisement.

7. The method of claim 1, further comprising:
resizing the received content data stream such that the received content data stream is presented on a first portion of the display; and
providing the received advertisement data stream to the second input of the display module such that the received advertisement data stream is presented on a second portion of the display.

8. The method of claim 1, further comprising overlaying the received advertisement data stream on the received content data stream such that at least a portion of content corresponding to the content data stream remains visible.

9. The method of claim 8, further comprising applying transparency to the advertisement data stream.

10. A method of presenting an advertisement comprising:
receiving advertisement data corresponding to an advertisement, wherein the advertisement data comprises a content criterion of an advertiser;
receiving content data corresponding to content;
comparing the received advertisement data to the received content data to determine whether the content criterion of the advertiser is satisfied;
receiving the advertisement and a presentation time for the advertisement; and
providing, if the content criterion is satisfied, the presentation time and the advertisement to a user device.

11. The method of claim 10, further comprising receiving an indication from the user device that the user device has requested the content.

12. The method of claim 10, wherein the received content data comprises at least one of a uniform resource locator at which content can be accessed, a language of the content, a genre of the content, a content type, a target audience of the content, a location at which the content is available, a price for presenting the advertisement during the content, a timeline comprising a time at which the advertisement is to be presented, a broadcast schedule of the content, and an advertising prohibition which prohibits a designated category of advertisements.

13. The method of claim 10, wherein the received advertisement data comprises at least one of a language of the advertisement, a duration of the advertisement, a desired language of the content, a desired genre of the content, a desired content type, an advertisement type, a desired target audience, a desired location at which the content is available, a desired language associated with the user device, and an advertising budget.

14. The method of claim 10, further comprising providing advertisement metadata to the user device, wherein the advertisement metadata comprises the presentation time for the advertisement.

15. The method of claim 10, further comprising determining a duration of the advertisement.

16. The method of claim 10, further comprising receiving viewer data from the user device, wherein the viewer data comprises at least one of an internet protocol address of the user device, a language associated with the user device, and a uniform resource locator associated with the content.

17. The method of claim 16, further comprising:
comparing the received viewer data to the received advertisement data; and
providing the presentation time and the advertisement to the user device only if at least a portion of the received viewer data is in agreement with at least a portion of the received advertisement data.

18. An advertising system comprising:
a content provider;
an advertiser; and
an advertisement manager configured to
receive advertisement data from the advertiser, wherein the advertisement data corresponds to an advertisement and comprises criteria of the advertiser;
receive content data from the content provider, wherein the content data corresponds to content;
receive viewer data from a user device;
compare the received advertisement data to the received content data and the received viewer data to determine whether the criteria of the advertiser is satisfied;
receive the advertisement and a presentation time for the advertisement from the advertiser; and
provide, if the criteria is satisfied, the presentation time and the advertisement to the user device.

19. The advertising system of claim 18, further comprising the user device, wherein the user device comprises a data stream application configured to:
receive the advertisement from the advertisement manager; and
present the received advertisement on a display of the user device.

20. The advertising system of claim 19, wherein the data stream application is further configured to provide the received advertisement to an input of a display module such that the received advertisement is presented simultaneously with the content.

21. The advertising system of claim 19, wherein the data stream application is further configured to provide the received advertisement to an input of a display module such that the received advertisement is presented to the exclusion of the content.

22. The advertising system of claim 19, wherein the presentation time corresponds to an elapsed time of the content, and further wherein the data stream application is further configured to monitor the elapsed time of the content such that the received advertisement is presented at the presentation time.

23. The advertising system of claim 18, wherein the viewer data comprises at least one of an internet protocol address of the user device, a language associated with the user device, and a uniform resource locator associated with the content.
